(19) United States
(12) Patent Application Publication
(10) Pub. No.: US 2006/0082738 A1
(43) Pub. Date: Apr. 20, 2006

(54) Projection apparatus

(75) Inventor: Sze-Ke Wang, Chu-Nan (TW)

Correspondence Address: BRUCE H. TROXELL;SUITE 1404, 5205 LEESBURG PIKE, FALLS CHURCH, VA, 22041, US

(73) Assignee: Coretronic Corporation

(21) Appl. No.: 11/233,048

(22) Filed: Sep. 23, 2005

(30) Foreign Application Priority Data
Oct. 19, 2004 (TW) 93131696

(51) Int. Cl. G03B 21/14

(52) U.S. Cl. 353/119

(57) ABSTRACT

A projection apparatus comprising a light valve disposed in a housing having an opening is provided. The opening is sealed by a transparent plate to separate inside and outside of the housing. A lens and a light source providing a light beam are disposed outside of housing. The light beam is guided by the lens and passes through the transparent plate to the light valve, thus a modulated light is formed on the light valve. The projection lens is used to guide the modulated light to project an image on a screen. A focus of the projection lens is adjustable to make the image on the screen clear and precise.

### BACKGROUND OF THE INVENTION

1. Field of the Invention

The invention relates to a projection apparatus, and more particularly to a structure in the projection apparatus that can efficiently lower temperature of a lens in the projection apparatus.

2. Description of the Prior Art

A projection apparatus is one of the most popular display devices, the basic structure of the projection apparatus 2 in the prior art is shown in FIG. 1. A light beam from a light-source 8, such as a lamp, passes through a lens 10 and is guided to a light valve 4 to form a modulated light, and then the modulated light passes through a projection lens 6 to project an image out of the projection apparatus 2.

Please refer to FIG. 2, the light valve 4 is disposed on an internal surface of a housing 14. The lens 10 is disposed on a front wall of the housing 14, and one side of the lens 10 is disposed in the housing 14, the other side is disposed outside the housing 14. One portion of the projection lens 6 is disposed on the front wall of the housing 14 and the other portion of the projection lens 6 is disposed outside the housing 14. Accordingly, the housing 14 prevents the light valve 4 and the portion of the projection lens 6 from any dust or pollution.

In order to endure the heat generated by the light beam from the light source 8, it is necessary to use glass material to fabricate the lens 10 in the prior art. However, the lens 10 formed glass material is expensive, for reducing a manufacturing cost of the lens 10, it is unavoidable to use plastic material to fabricate the lens 10 and a cooling fan 15 must be integrated adjacent to the lens 10 for cooling the lens 10. Thus a material cost and an assembling cost of the projection apparatus 2 inevitably increase attributed to the cooling fan 15. This is the first disadvantage resulted from the projection apparatus 2 using cooling fan 15 in the projection apparatus 2.

After adding the cooling fan 15, the cooling efficiency is still poor because the cooling fan 15 only blows over one side of the lens 10 outside the housing 14. If an additional cooling fan is integrated into the housing 14, the two cooling fans may blow both sides of the lens 10 to lower the temperature of the lens 10 effectively. However, the two cooling fans result more material cost and assembling cost, and the airflow resulted from the additional cooling fan can further bring contamination to the light valve 4 and the portion of the projection lens 6.

### SUMMARY OF THE INVENTION

It is one object of the present invention to provide a structure in a projection apparatus that can lower temperature of a lens formed of plastic material, keep a light valve completely sealed within a housing, and prevent the light valve from any pollution.

The present invention is related to a projection apparatus comprising a light valve, a transparent plate, a light source, the lens, and a projection lens. The light valve is disposed on an internal surface of a housing having an opening. The transparent plate is used to seal the opening to completely seal the housing. The light source is installed outside the housing to provide a light beam. The lens is installed outside the housing and is used to guide the light beam through the transparent plate to the light valve, and then the light valve generates a modulated light carrying an image. The projection lens is used to guide the modulated light to project the image on a screen. One portion of the projection lens is disposed in the housing or installed outside the housing.

The projection apparatus further comprises a cooling fan installed outside of the housing to blow airflows on both sides of the lens, and the temperature of the lens is greatly reduced. Thus the plastic material with low cost is suitable for the fabrication of the lens to resist heat from the light source in the present invention, which is much more easily for manufacturing. In addition, the light valve is disposed in the housing sealed by the transparent plate, so there is no possibility to pollute the elements, including the light valve, within the housing.

### BRIEF DESCRIPTION OF THE DRAWINGS

The present invention will now be specified with reference to its preferred embodiment illustrated in the drawings, in which:

FIG. 1 schematically illustrates a projection apparatus in the prior art;

FIG. 2 schematically illustrates the cross-sectional view of a projection apparatus in the prior art;

FIG. 3 schematically illustrates the cross-sectional view of the first preferred embodiment projection apparatus according to the present invention;

FIG. 4 schematically illustrates the cross-sectional view of the second preferred embodiment projection apparatus according to the present invention;

FIG. 5 schematically illustrates the cross-sectional view of a housing, which details another embodiment of the transparent plate of the projection apparatus according to the present invention; and

FIG. 6 schematically illustrates the cross-sectional view of a transparent plate according to the present invention.

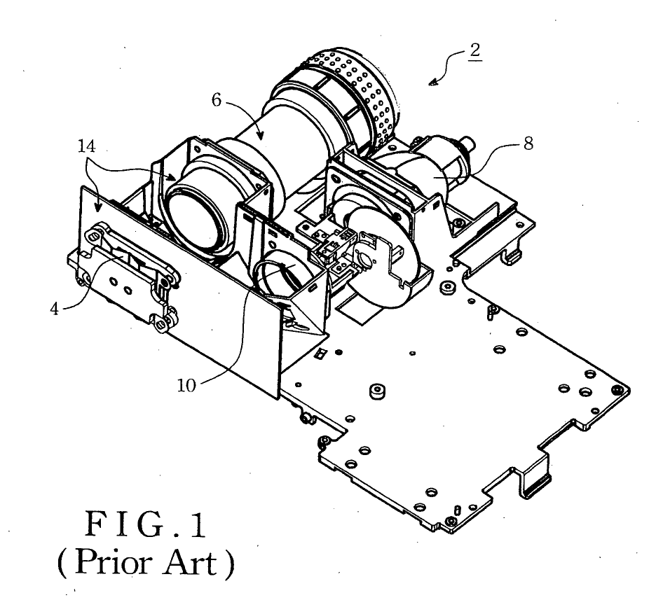

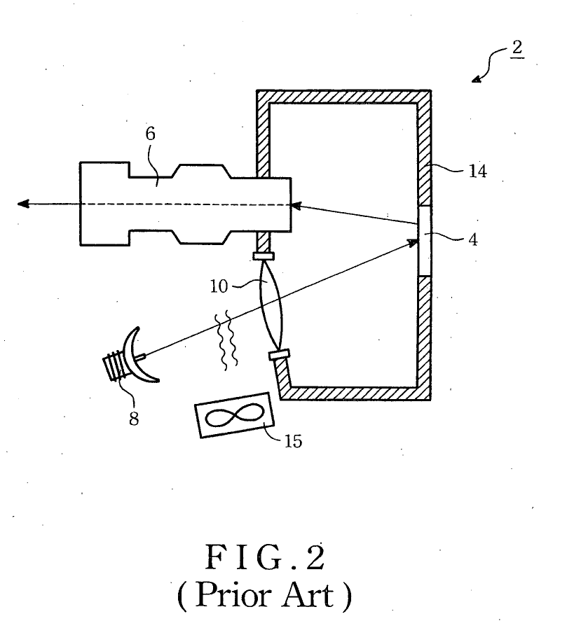

### DESCRIPTION OF THE PREFERRED EMBODIMENT

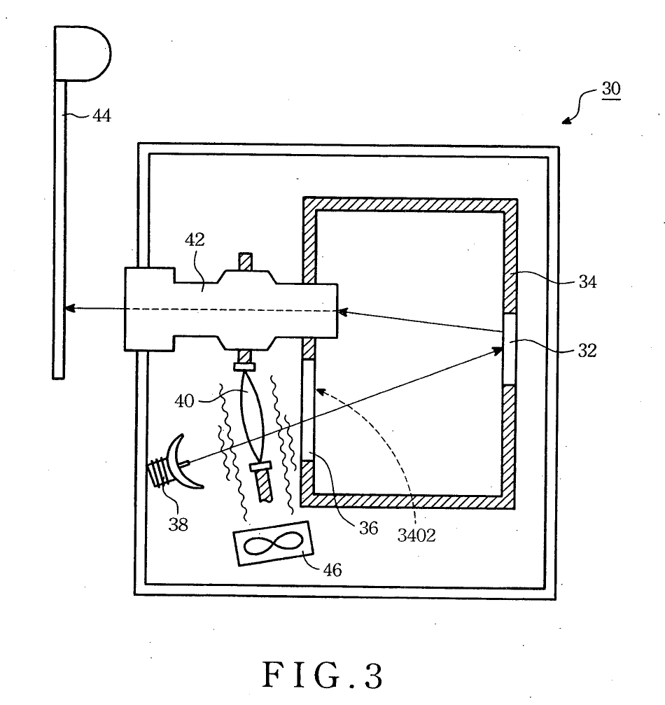

Please refer to FIG. 3 which schematically illustrates the cross-sectional view of a projection apparatus 30 according to the first preferred embodiment of the present invention, the projection apparatus 30 comprises a light valve 32, a light source 38 for providing a light beam, a lens 40, and the projection lens 42. The light valve 32 is disposed on an internal surface of a housing 34 for generating a modulated light carrying an image. A front wall of the housing 34 includes an opening 3402 for allowing the light beam from the light source 38 to enter the housing 34. A transparent plate 36 is used to seal the opening 3402 to seal the housing 34, and the transparent plate 36 can be made of glass or plastic material. Furthermore, the interior portion of the housing 34 can prevent away from any dust or pollution accumulation, and the light valve 32 can be sealed within the housing 34. The light valve 32 is composed of Digital Micro-mirror Device (DMD) or Liquid-Crystal-on-Silicon (LCOS).

The light source 38, such as a high-pressure mercury lamp, a metal halide lamp or a xenon lamp, is installed outside the housing 34.

The lens 40 is installed outside the housing 34 and placed between the light source 38 and the transparent plate 36 of the housing 34. The light beam from the light source 38 passes through the lens 40 and the transparent plate 36 to enter the housing 34 and project on the light valve 32, and the modulated light reflected from the light valve 32 passes through the projection lens 42 to project on a screen 44.

One portion of the projection lens 42 is disposed on the front wall of the housing 34, and the other portion is disposed outside the housing 34. The projection lens 42 is used to guide the modulated light to project the image on the screen 44, and focus of the projection lens 42 is adjustable to make the image on the screen 44 clear and precise.

In addition, a cooling fan 46 is disposed outside the housing 34 and adjacent to the lens 40 for blowing airflows to both sides of the lens 40. The temperature of the lens 40 is lowered effectively by air convection and the blowing of the cooling fan 46.

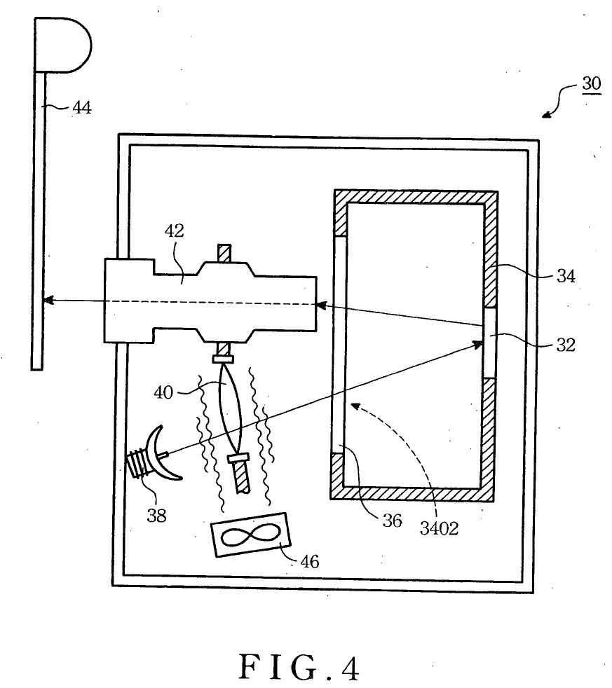

Please refer to FIG. 4 which schematically illustrates the cross-sectional view of the projection apparatus 30 according to the second preferred embodiment of the present invention. The projection lens 42 is disposed completely outside the housing 34 and adjacent to the transparent plate 36. Thus, the temperature of both sides of the lens 40 and the whole projection lens 42 can be lowed. The modulated light from the light valve 32 passes through the transparent plate 36, and then is guided by the projection lens 42 outside the housing 34 to project the image on the screen 44.

Please refer to FIG. 3 and FIG. 4, the lens 40 of the projection apparatus 30 is formed of a plastic material with lower cost. Accordingly, the plastic material is such as Poly Methyl Methacrylate (PMMA), ARTON (transparent plastic with excellent resistance to heat), Polycarbonate (PC), Allyl Diglycol Carbonate (ADC), Cyclo-olefin Copolymer (TOPAS), APEL, O-PET and ZEONEX.

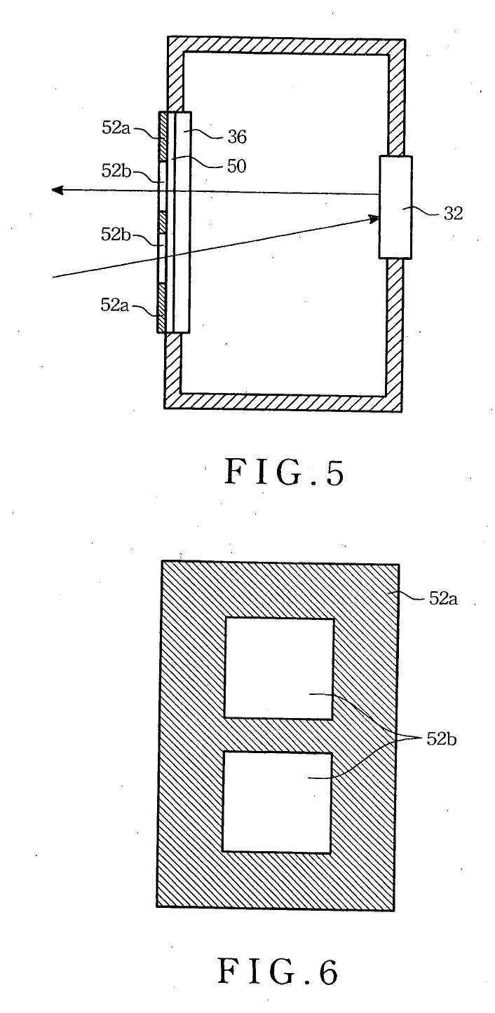

Please refer to FIG. 5, the transparent plate 36 is coated with an anti-reflection layer 50 and an opaque layer 52a formed on the anti-reflection layer 50. The anti-reflection layer 50 can eliminate the reflection from the transparent plate 36. Please refer to FIG. 6, the opaque layer 52a comprises two separate transparent openings 52b. The separate transparent openings 52b on the opaque layer 52a are used to respectively pass the light beam from the light source 38 into the housing 34 and to pass the modulated light from the light valve 32 out of the housing 34 to the projection lens 42. Because of the opaque layer 52a, the unexpected light, such as the light from the improper light path, is filtered and the contrast of the image projected on the screen 44 is improved.

In accordance with the projection apparatus 30 in the present invention, the lens 40 is installed completely outside the housing 34, the cooling fan 46 can blow airflow on more than one side of the lens 40 to rapidly lower the temperature of the lens 40. The lens 40 formed of plastic material can lower the manufacturing cost of the lens. In addition, the housing 34 completely seals the light valve 32 and prevents the light valve from any dust or pollution accumulation.

While the preferred embodiments of the present invention have been set forth for the purpose of disclosure, modifications of the disclosed embodiments of the present invention as well as other embodiments thereof may occur to those skilled in the art. Accordingly, the appended claims are intended to cover all embodiments, which do not depart from the spirit and scope of the present invention.

What is claimed is:

1. A projection apparatus comprising:
a housing having an opening and a transparent plate sealed said opening to seal said housing;
a light source installed outside of said housing for generating a light beam;
a lens disposed outside of said housing and between said light source and said housing, said lens for guiding said light beam to pass through said transparent plate into said housing;
a light valve disposed in said housing for reflecting said light beam to form a modulated light; and
a projection lens for guiding said modulated light to project an image on a screen.

2. The projection apparatus of claim 1, further comprising a cooling fan installed outside said housing for blowing airflows directly to more than one side of said lens.

3. The projection apparatus of claim 1, wherein one portion of said projection lens is disposed in said housing.

4. The projection apparatus of claim 1, wherein said projection lens is disposed completely outside said housing.

5. The projection apparatus of claim 1, wherein said lens is formed of plastic material.

6. The projection apparatus of claim 1, wherein said transparent plate includes an anti-reflection layer coated on a surface of said transparent plate.

7. The projection apparatus of claim 1, wherein said transparent plate includes an opaque layer for blocking a light except said light beam and said modulated light.

8. The projection apparatus of claim 1, wherein said light valve comprises a digital micro-mirror device.
